(19) United States
(12) Patent Application Publication
(10) Pub. No.: US 2022/0072917 A1
(43) Pub. Date: Mar. 10, 2022

(54) Removable Sanitary Cover for Mobitity Assistance Equipment

(71) Applicant: Lemmell Brown, Lacy, WA (US)

(72) Inventor: Lemmell Brown, Lacy, WA (US)

(21) Appl. No.: 17/013,235

(22) Filed: Sep. 4, 2020

(51) Int. Cl. B60C 27/06; A61G 5/10; A61H 3/04

(52) U.S. Cl. CPC B60C 27/06; A61H 3/04; A61G 5/10

(57) ABSTRACT

A removable sanitary cover is disclosed, which may encase a wheel or a distal end of a leg of mobility assistance equipment or another object. The removable sanitary cover may comprise an elongated casing having a piece of elastic woven into and along each lateral edge of the casing such tension of the elastic causes the lateral edges of the casing to “hug” or envelope the wheel, providing a protective covering for the wheel. Closures disposed at each distal end of the casing may couple to achieve a secure fit. The method of using the removable sanitary cover may allow a user to reduce the transfer of contaminants into an area.

### FIELD

The present disclosure relates to sanitary covers for mobility assistance equipment, for example, canes, walkers, crutches, scooters, wheelchairs, carts, or other objects having a leg extremity or a wheel. More particularly, the present disclosure relates to a removable sanitary cover having an enclosure that is adaptable to a wheel and is held in place with a hook-and-loop closure or another type of closure.

### BACKGROUND

Mobility assistance equipment is an indispensable tool for many people with injuries or limited mobility. People may shift their weight to such equipment to walk of their own volition or to receive extra stability. People also use mobility assistance equipment to transport themselves or their belongings. Unfortunately, bringing such equipment to an outdoor or unclean space can mean picking up dirt or contaminants, and tracking such dirt or contaminants throughout a user's home or indoor environment. This may also result in a slip-and-fall injury, a contracted illness, property damage, or another hardship.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The present disclosure is directed to a removable sanitary cover operable to encase a wheel on a piece of mobility assistance equipment. In one implementation, the removable sanitary cover may comprise an elongated casing having a closure, for example, a hook-and-loop fastener or a snap button, disposed at each distal end of the casing. The casing may, for example, be made of fabric, which may be waterproof, antibacterial, washable, or stretchable. A piece of elastic may be woven into and along each lateral edge of the casing. Each piece of elastic may have a length that is shorter than the length of casing, such that each elastic creates a gathering along each said lateral edge of the casing.

In one example, a user may wrap the removable sanitary cover circumferentially about a wheel or a leg extremity of a piece of mobility assistance equipment, such as a scooter, a wheelchair, a cart, a cane, a walker, a crutch, or the like, or over another object. For example, the user may secure the removable sanitary cover to a wheel by coupling the closures disposed at the distal ends of the casings. The tension of the elastic may cause the lateral edges of the casing to “hug” or envelope the wheel to provide a fitted protective covering for the wheel. The closures may keep the removable sanitary cover fittingly secured to the wheel until an external force removes it from the wheel by decoupling the closures.

Using the cover may allow a user to reduce the transfer of contaminants into an area, which may reduce a risk of injury, of illness, of property damage, or of other hardships, by keeping the wheel or the distal end of the object covered in one type environment (for example, indoors) and removing it when moving to a different environment (for example, outdoors). In this way, the wheel or the distal end of the leg extremity of the object may be kept reasonably clean when applying a freshly-washed or new sanitary cover to the wheel or the leg extremity.

### BRIEF DESCRIPTION OF THE DRAWINGS

The present description may be better understood from the following detailed description read in light of the appended drawings, wherein:

FIG. 1 illustrates a top view of a removable sanitary cover when laid generally flat in an open position, according to one implementation.

FIG. 2 illustrates a perspective view of a removable sanitary cover fittingly secured to a wheel of a piece of mobility assistance equipment, according to one implementation.

FIG. 3 illustrates a perspective view of a removable sanitary cover fittingly secured to a wheel of a piece of mobility assistance equipment, according to one implementation.

FIG. 4 illustrates a perspective view of a removable sanitary cover fittingly secured to a wheel of a piece of mobility assistance equipment, according to another implementation.

### DETAILED DESCRIPTION

A more particular description of certain implementations of Baby Carrier may be had by references to the implementations shown in the drawings that form a part of this specification, in which like numerals represent like objects.

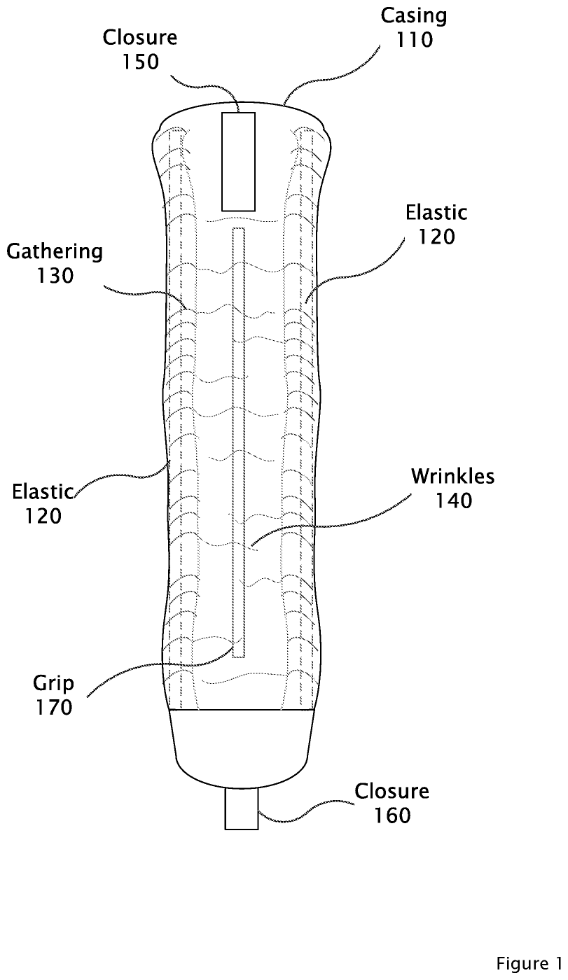

FIG. 1 illustrates a top view of a Removable Sanitary Cover for Mobility Assistance Equipment and the Like 100 when laid generally flat in an open position. In one implementation, Removable Sanitary Cover for Mobility Assistance Equipment and the Like 100 may comprise an elongated Casing 310 having a Closure 150 and a Closure 160, for example, a hook-and-loop fastener, a button, a clip, a pin, an adhesive, or a magnet, disposed at each distal end of Casing 110. Casing 110 may be made of a waterproof, antibacterial, stretchable, or washable fabric, or another material. A piece of Elastic 120 may be woven into and along each lateral edge of Casing 110. Each piece of Elastic 120 may have a length that is shorter than the length of Casing 110 such that each Elastic 120 creates a Gathering 130 along each said lateral edge of Casing 110. The Gathering 130 created by the Elastic 120 may create Wrinkling 140 along or near the longitudinal centerline of Casing 110 when Casing 110 is laid generally flat in an open position.

A user may wrap Removable Sanitary Cover for Mobility Assistance Equipment and the Like 100 circumferentially about a wheel or a leg extremity of an object. The user may secure the removable sanitary cover to the wheel by coupling Closure 150 with Closure 160 disposed at the distal ends of Casing 110, keeping the cover secure until an external force removes the sanitary cover from the wheel or the leg extremity by decoupling the closures. Upon closure of the sanitary cover, the tension of Elastic 120 may cause the lateral edges of Casing 110 to “hug” or envelope the wheel to provide a fitted protective covering for the wheel. The removable sanitary cover may fit over a wheel of a piece of mobility assistance equipment, such as a scooter, a wheelchair, a cart, a cane, a walker, a crutch, or the like, or another object, for example, a vehicle. In another implementation, the removable sanitary cover may comprise a circular or loop shape, which may eliminate a need for closures, and may be made different shapes and sizes to accommodate different size wheels or other objects.

In one embodiment, the sanitary cover may also include a Grip 170 or skid-resistant surface applied to Casing 110 to provide more support to the user. In another embodiment, Casing 110 may include an aesthetic design or a space for a logo or other indicia.

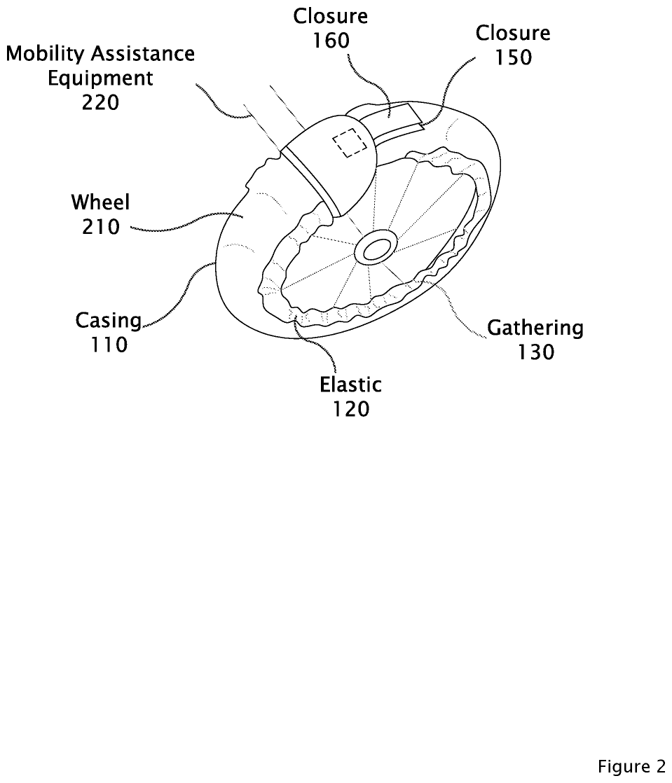

FIG. 2 illustrates a perspective view of Removable Sanitary Cover for Mobility Assistance Equipment and the Like 100 fittingly secured to a Wheel 210 of Mobility Assistance Equipment 220. In one implementation, a user may place Casing 110 circumferentially about Wheel 210 and couple Closure 150 to Closure 160 to secure the removable sanitary cover to Wheel 210. The tension of Elastic 120, which may be woven inside and along each lateral edge of Casing 110, may cause the lateral edges of Casing 110 to “hug” or envelope Wheel 210 to provide a fitted protective covering. Elastic 120 may create a Gathering 130 of fabric along the lateral edges of Casing 110, allowing coverage for different-sized wheels while providing a generally smooth surface along the longitudinal centerline of Casing 110, facilitating a smooth ride or experience for the user. Closure 150 and Closure 160 may help keep the removable sanitary cover fittingly secured to Wheel 210 until an external force removes it from Wheel 210 by decoupling the closures.

In another implementation, a user may lay the sanitary removable cover generally flat on a surface and cause Wheel 210 to move over the cover, causing the cover to wrap circumferentially about Wheel 210. In this example, Closure 150 and Closure 160 may comprise magnets that may automatically secure the sanitary removable cover to Wheel 210 by magnetic force.

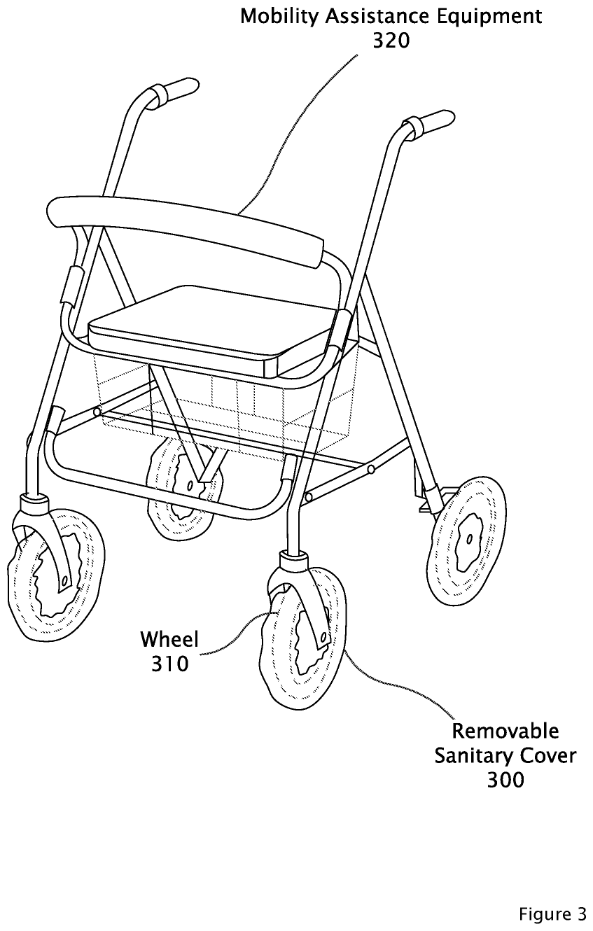

FIG. 3 illustrates a perspective view of Removable Sanitary Cover for Mobility Assistance Equipment 300 fittingly secured to encase each Wheel 310 of a piece of Mobility Assistance Equipment 320, for example, a medical scooter.

Using Removable Sanitary Cover for Mobility Assistance Equipment 300 may allow a user to reduce the transfer of contaminants into an area, to reduce risk of injury, illness, property damage, or to otherwise reduce hardship, by keeping Wheel 310 or the distal end of Mobility Assistance Equipment 320 covered in one type environment (for example, indoors) and removing it when moving to a different environment (for example, outdoors). In this way, Wheel 310 or the distal end of the leg extremity of Mobility Assistance Equipment 320 may be kept reasonably clean when applying a freshly-washed or new sanitary cover to the wheel or the leg extremity.

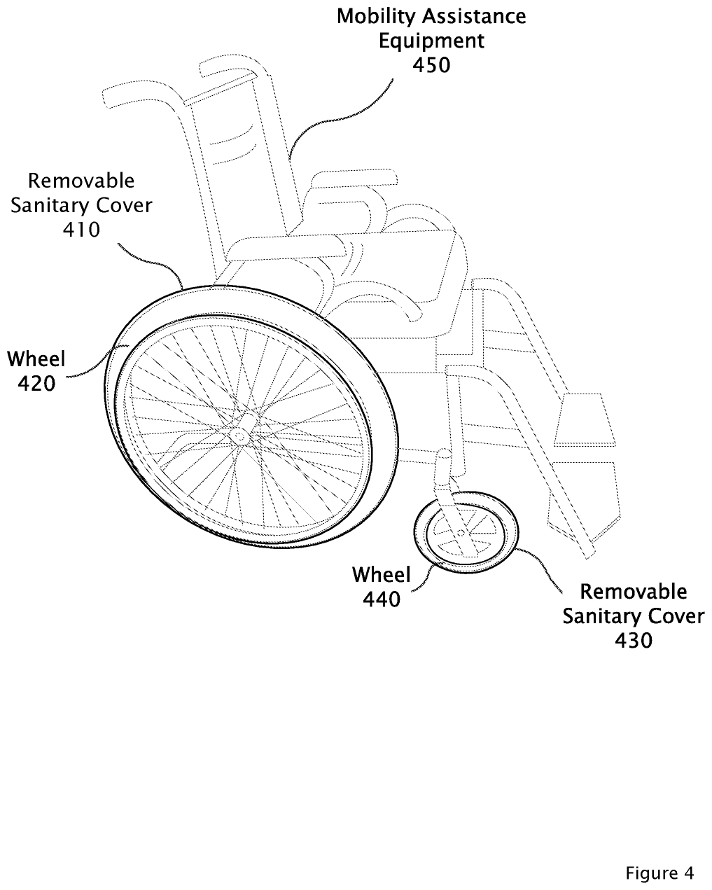

FIG. 4 illustrates a perspective view of a Removable Sanitary Cover for Mobility Assistance Equipment 400. In this implementation, Removable Sanitary Cover 410 may fittingly encase Wheel 420, and Removable Sanitary Cover 430 may fittingly encase a smaller Wheel 440 of a piece of Mobility Assistance Equipment 450, for example, a wheelchair.

One implementation may include a method of using the disclosed removable sanitary cover. Another implementation may include a method of removing the sanitary cover as described above when the user comes inside or into a sanitary environment. Another implementation may also include a method to the reverse situation, namely, where the sanitary cover is only used in outdoor or dirty environments and removed for indoor environments.

The illustrated embodiments are only examples of the present invention and, therefore, are non-limitive. It is to be understood that many changes in the particular structure, materials, and features of the invention may be made without departing from the spirit and scope of the invention.

Therefore, the Applicant intends that her patent rights not be limited by the particular embodiments illustrated and described herein, but rather by the following claims interpreted according to accepted doctrines of claim interpretation, including the Doctrine of Equivalents and Reversal of Parts.

1. A removable sanitary cover, comprising:
a casing,
a piece of elastic, wherein the piece of elastic is woven into and along each lateral edge of the casing, wherein each piece of elastic has a length that is shorter than the length of the casing such that each elastic creates a gathering along each said lateral edge of the casing.

2. The removable sanitary cover of claim 1, wherein the casing includes at least one closure disposed on each distal end of the casing.

3. The removable sanitary cover of claim 2, wherein the at least one closure comprises a closure selected from the list including a hook-and-loop fastener, a button, a clip, a pin, an adhesive, or a magnet.

4. The removable sanitary cover of claim 1, wherein the casing comprises a circular or loop shape.

5. The removable sanitary cover of claim 1, wherein the casing is made of a waterproof, antibacterial, stretchable, or washable fabric.

6. The removable sanitary cover of claim 1, further including a grip or a skid-resistant surface applied to a surface of the casing.

7. The removable sanitary cover of claim 1, further including an aesthetic design or a space for a logo or other indicia.
